(19) United States
(12) Patent Application Publication
(10) Pub. No.: US 2021/0049007 A1
(43) Pub. Date: Feb. 18, 2021

(54) ELECTRONIC SYSTEM FOR DYNAMIC GENERATION OF DEPENDENCY LIBRARIES ASSOCIATED WITH DISPARATE FRAMEWORKS

(71) Applicant: BANK OF AMERICA CORPORATION, Charlotte, NC (US)

(72) Inventors: Govinda Rajulu Nelluri, Hyderabad (IN); Birudharaju Shashank Raju, Hyderabad (IN)

(73) Assignee: BANK OF AMERICA CORPORATION, Charlotte, NC (US)

(21) Appl. No.: 16/542,870

(22) Filed: Aug. 16, 2019

(51) Int. Cl. G06F 8/71; G06N 20/00; G06F 16/951; G06F 8/41

(52) U.S. Cl. CPC G06F 8/71; G06F 8/433; G06F 16/951; G06N 20/00

(57) ABSTRACT

An electronic system is typically configured for crawling into at least one code repository comprising one or more codes that are associated with one or more applications that are in development phase, wherein the one or more applications are associated with disparate frameworks, identifying, via a machine learning model, one or more dependencies associated with the one or more codes based on crawling into the at least one code repository, determining that the one or more dependencies are present in an internal library repository, generate dependency libraries by downloading the one or more dependencies from the internal library repository, and providing the one or more dependencies downloaded from the internal library repository for building the one or more codes for deployment, wherein the one or more dependencies are utilized for building dependency libraries associated with codes that require same dependencies as that of the one or more codes.

### BACKGROUND

Currently conventional systems do not have the capability to dynamically generate dependency libraries associated with disparate frameworks. As such, there exists a need for a system to dynamically generate dependency libraries associated with disparate frameworks.

### BRIEF SUMMARY

Embodiments of the present invention address the above needs and/or achieve other advantages by providing apparatuses (e.g., a system, computer program product and/or other devices) and methods dynamically generating dependency libraries associated with disparate frameworks. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may crawl into at least one code repository comprising one or more codes that are associated with one or more applications, wherein the one or more applications are associated with disparate frameworks, identify, via a machine learning model, one or more dependencies associated with the one or more codes based on crawling into the at least one code repository, determine that the one or more dependencies are present in internal library repository, download the one or more dependencies from the internal library repository, and provide the one or more dependencies downloaded from the internal library repository to a build and deploy tool for building the one or more codes for deployment.

In some embodiments, the one or more applications are in development phase.

In some embodiments, the system crawls into the at least one code repository based on identifying that at least one user checked in the one or more codes to the at least one code repository.

In some embodiments, the system identifies the one or more dependencies based on automatically reading the one or more codes in the one or more codes repositories.

In some embodiments, the system identifies the one or more dependencies based on automatically reading one or more inputs provided by the at least one user while developing the one or more codes.

In some embodiments, the system identifies, that the one or more dependencies associated with the one or more codes are not present in the internal library repository and generates the dependency libraries by downloading the one or more dependencies from at least one third party entity system.

In some embodiments, the system identifies, via the machine learning model, a failure associated with building the one or more codes for deployment and resolves the failure associated with building the one or more codes for deployment.

In some embodiments, the system identifies that the failure associated with building the one or more codes based on determining that at least one dependency of the one or more dependencies is non-existent.

In some embodiments, the system resolves the failure by downloading the at least one dependency that is non-existent.

In some embodiments, the system provides information associated with the failure to the machine learning model and train the machine learning model.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for dynamically generating dependency libraries associated with disparate frameworks, in accordance with an embodiment of the invention;

FIG. 2 provides a block diagram illustrating the entity system 200 of FIG. 1, in accordance with an embodiment of the invention;

FIG. 3 provides a block diagram illustrating a dependency library generation system 300 of FIG. 1, in accordance with an embodiment of the invention;

FIG. 4 provides a block diagram illustrating the computing device system 400 of FIG. 1, in accordance with an embodiment of the invention;

FIG. 5 provides a block diagram illustrating the process of dynamically generating dependency libraries associated with disparate frameworks, in accordance with an embodiment of the invention; and

FIG. 6 provides a flowchart illustrating a process flow dynamically generating dependency libraries associated with disparate frameworks, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the term “entity” may include any organization that develops software applications. Furthermore, embodiments of the present invention use the term “user.” It will be appreciated by someone with ordinary skill in the art that the user may be an employee of the entity. In accordance with embodiments of the present invention, the term “third party entity” may be any third-party system or website on the internet. In an embodiment of the present invention, the entity may be a financial institution and a user may be an employee (e.g., application developer) of the financial institution.

In accordance with embodiments of the present invention, the term “software application” may be any application that is being developed by the entity. In accordance with embodiments of the present invention, the term “dependency library” may be any library or module that a user uses while developing a software application. The dependency library may include one or more functionalities bundled together.

Typically, one or more codes are developed by developers of an entity to build applications. Each of the one or more codes are developed in multiple languages (e.g., multiple programming language frameworks) in a development environment and are deployed to production environment. One or more codes may require one or more dependency libraries for the functions of the one or more codes to work. In larger entities, software applications are used to move the code to production scenario. With this way of managing deployment, dependency libraries that are associated with the one or more codes are typically maintained over internet and the build tools download the required libraries from the internet. For security purposes, some larger entities may not allow these libraries to be directly downloaded into the user devices of developers. As an alternative to downloading off the internet approach, large entities are currently managing internal library repositories like where required dependency libraries are downloaded and stored. However, the internal library repositories are maintained by separate management teams and each of the developers typically ask the management team to download the required dependencies into local repositories before the building and deploying the one or more codes to a next environment. The approach of maintaining separate internal library repositories to save all the dependency libraries may be rudimentary. In the case where there are multiple teams comprising multiple developers working on multiple software applications, the process of asking the management team to download dependency libraries may not efficient. As such, there exists a need for a system to efficiently download dependency libraries associated with one or more software applications that are being developed by entities before the build and deploy phase.

The present invention circumvents all the above-noted issues by efficiently downloading dependency libraries associated with one or more software applications that are being developed by entities before the initiation of build and deploy process. The system of the present invention comprises a machine learning module that understands dependencies associated with the one or more codes that are associated with different programming language frameworks and prepares the dependency libraries before building and deploying the one or more codes to a next environment. The system of the present invention also identifies build failures and automatically downloads the dependency libraries again and runs the build to successfully deploy the one or more codes to the next environment.

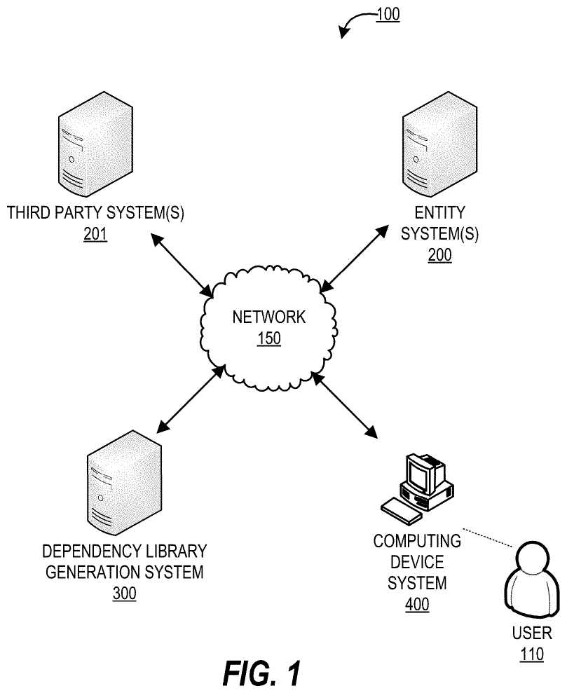

FIG. 1 provides a block diagram illustrating a system environment 100 for dynamically generating dependency libraries associated with disparate frameworks, in accordance with an embodiment of the invention. As illustrated in FIG. 1, the environment 100 includes a dependency library generation system 300, entity system 200, a computing device system 400, and one or more resource entity systems 201. One or more users 110 may be included in the system environment 100, where the users 110 interact with the other entities of the system environment 100 via a user interface of the computing device system 400. In some embodiments, the one or more user(s) 110 of the system environment 100 may be employees of an entity associated with the entity system 200.

The entity system(s) 200 may be any system owned or otherwise controlled by an entity to support or perform one or more process steps described herein. In some embodiments, the entity is a financial institution.

The dependency library generation system 300 is a system of the present invention for performing one or more process steps described herein. In some embodiments, the dependency library generation system 300 may be an independent system. In some embodiments, the dependency library generation system 300 may be a part of the entity system 200.

The dependency library generation system 300, the entity system 200, the computing device system 400, and/or the resource entity systems 201 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the dependency library generation system 300 is configured to communicate information or instructions with the entity system 200, the computing device system 400, and/or the resource entity systems 201 across the network 150.

The computing device system 400 may be a computing device of the user 11. In general, the computing device system 400 communicates with the user 110 via a user interface of the computing device system 400, and in turn is configured to communicate information or instructions with the dependency library generation system 300, entity system 200, and/or the resource entity systems 201 across the network 150.

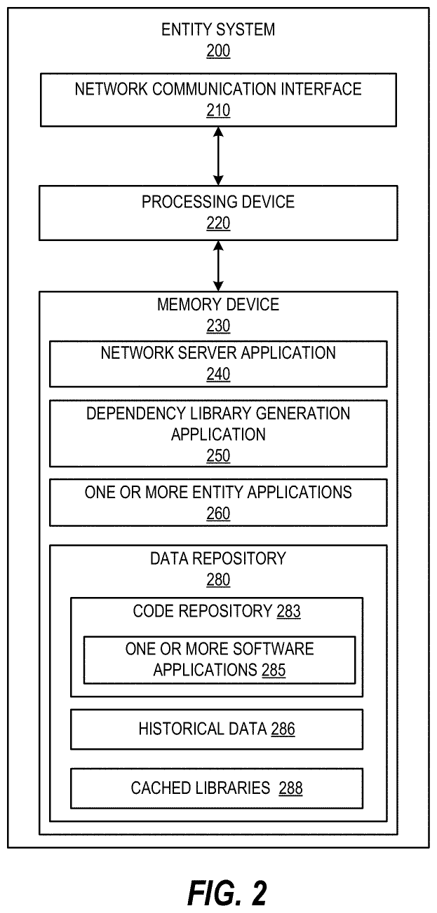

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In some embodiments, the entity system 200 may be operated by any entity that develops software applications. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a network server application 240, a dependency library generation application 250, one or more entity applications 260, and a data repository 280 comprising code repository 283, historical data 286, and internal library repository 288. The code repository 283 may include one or more software applications 285. In some embodiments, the one or more entity applications 260 may include any tools or applications that are used by the entity for software integration and deployment process. The computer-executable program code of the network server application 240, the dependency library generation application 250, and the one or more entity applications 260 to perform certain logic, data-extraction, and data-storing functions of the entity system 200 described herein, as well as communication functions of the entity system 200.

The network server application 240, the dependency library generation application 250 and the one or more entity applications 260 are configured to store data in the data repository 280 or to use the data stored in the data repository 280 when communicating through the network communication interface 210 with the dependency library generation system 300, the computing device system 400, and/or the third party systems 201 to perform one or more process steps described herein. In some embodiments, the entity system 200 may receive instructions from the dependency library generation system 300 via the dependency library generation application 250 to perform certain operations. The dependency library generation application 250 may be provided by the dependency library generation system 300.

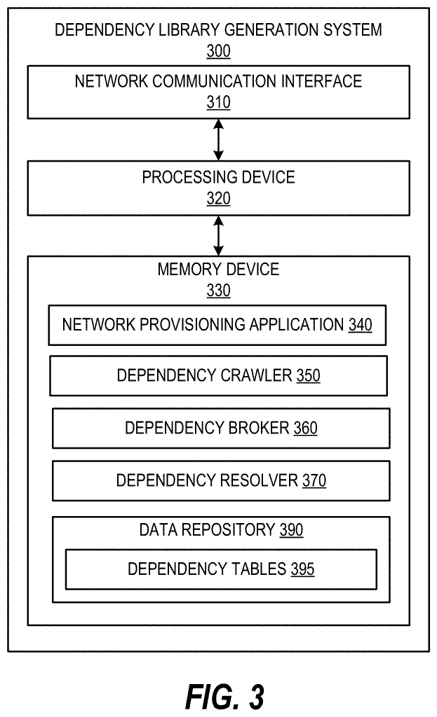

FIG. 3 provides a block diagram illustrating the dependency library generation system 300 in greater detail, in accordance with embodiments of the invention. As illustrated in FIG. 3, in one embodiment of the invention, the dependency library generation system 300 includes one or more processing devices 320 operatively coupled to a network communication interface 310 and a memory device 330. In certain embodiments, the dependency library generation system 300 is operated by a first entity, such as a financial institution, while in other embodiments, the dependency library generation system 300 is operated by an entity other than a financial institution. In some embodiments, the dependency library generation system 300 is owned or operated by the entity of the entity system 200. In some embodiments, the dependency library generation system 300 may be an independent system. In alternate embodiments, the dependency library generation system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the dependency library generation system 300 described herein. For example, in one embodiment of the dependency library generation system 300, the memory device 330 includes, but is not limited to, a network provisioning application 340, a dependency crawler 350, a dependency broker 360, a dependency resolver 370, and a data repository 390 comprising dependency tables 395 and data processed or accessed by one or more applications in the memory device 330. The computer-executable program code of the network provisioning application 340, the dependency crawler 350, the dependency broker 360, and the dependency resolver 370 may instruct the processing device 320 to perform certain logic, data-processing, and data-storing functions of the dependency library generation system 300 described herein, as well as communication functions of the dependency library generation system 300.

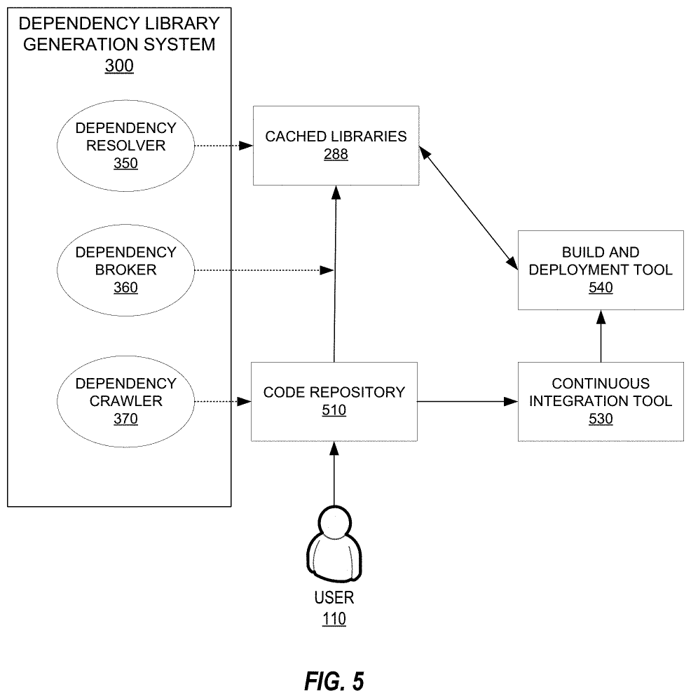

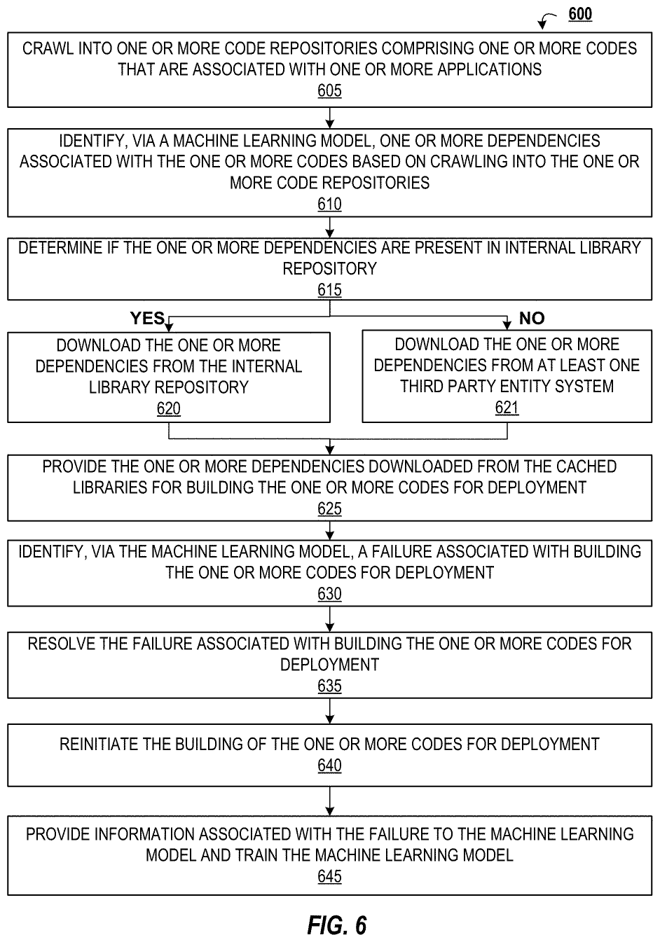

The network provisioning application 340, the dependency crawler 350, the dependency broker 360, and the dependency resolver 370 are configured to invoke or use the data in the data repository 390 when communicating through the network communication interface 310 with the entity system 200, the computing device system 400, and/or the resource entity systems 201. In some embodiments, the network provisioning application 340, the dependency crawler 350, the dependency broker 360, and the dependency resolver 370 may store the data extracted or received from the entity system 200, the third party entity system 201, and the computing device system 400 in the data repository 390. In some embodiments, the network provisioning application 340, the dependency crawler 350, the dependency broker 360, and the dependency resolver 370 may be a part of a single application. One or more processes performed by the network provisioning application 340, the dependency crawler 350, the dependency broker 360, and the dependency resolver 370 are described in FIG. 5 and FIG. 6.

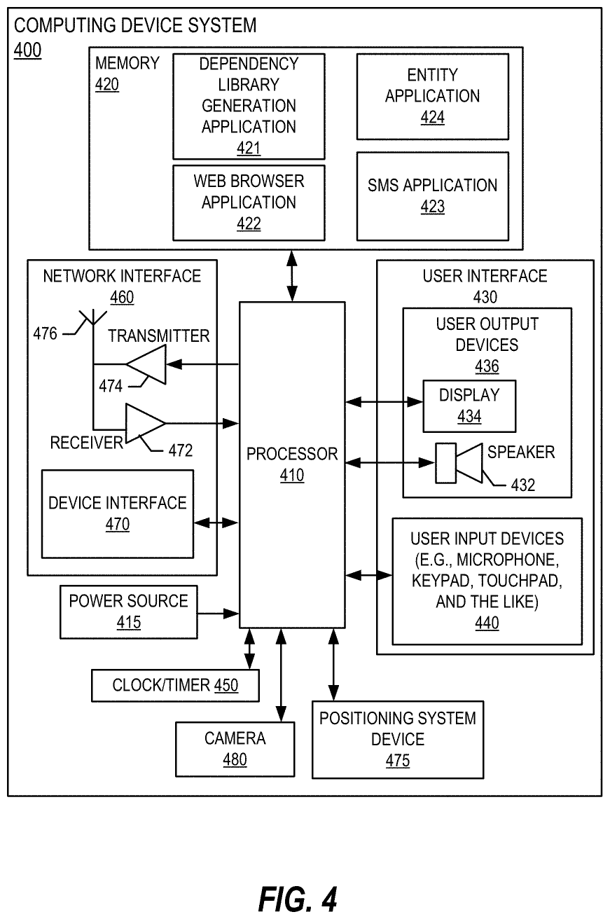

FIG. 4 provides a block diagram illustrating a computing device system 400 of FIG. 1 in more detail, in accordance with embodiments of the invention. However, it should be understood that the computing device system 400 is merely illustrative of one type of computing device system that may benefit from, employ, or otherwise be involved with embodiments of the present invention and, therefore, should not be taken to limit the scope of embodiments of the present invention. The computing devices may include any one of portable digital assistants (PDAs), pagers, mobile televisions, mobile phone, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110 may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a dependency library generation application 421, an entity application 424, or the like. These applications also typically instructions to a graphical user interface (GUI) on the display 430 that allows the user 110 to interact with the entity system 200, the dependency library generation system 300, and/or other devices or systems. The memory 420 of the computing device system 400 may comprise a Short Message Service (SMS) application 423 configured to send, receive, and store data, information, communications, alerts, and the like via the wireless telephone network 152.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

FIG. 5 provides a block diagram illustrating the process of dynamically generating dependency libraries associated with disparate frameworks, in accordance with an embodiment of the invention. When the user 110 develops code associated with a software application using a programming framework on the computing device system 400 and checks in the code to the code repository 510, the dependency crawler 350 crawls into code repository 510 and identifies one or more dependencies that are associated with the code that is checked into the code repository 510. The dependency crawler 350 after identifying the one or more dependencies, sends an input to the dependency broker 360, where the input may be a dependency chart comprising the one or more dependencies associated with the code. The dependency broker 360 upon receiving the input, determines whether the one or more dependencies in the dependency chart are present in the internal library repository 288. In the case, where the one or more dependencies are not present in the internal library repository 288, the system downloads the non-existent dependencies from a third-party entity system 201. In some embodiments, the third-party entity system 201 may be an entity or a website approved by the entity system 200. This process happens right after the user 110 checks-in the code into the code repository 510 and before the build process that is initiated by the build and deployment tool 540. When the user 110 checks-in the code into the code repository 510, the continuous integration tool versions the code and maintains the versions of the code in correct pipelines so that the correct versions are ready for deployment to the next environment. Once the build and deployment tool 540 initiates the build process, the dependency resolver 370 identifies whether the build process is successful or not. In an embodiment, where the build process is unsuccessful, the dependency resolver accesses a log associated with the build and deployment tool 540 to identify the one or more dependencies that are associated with the failure of the build process. The dependency resolver 370 in response to identifying the dependencies that are causing the failure, downloads alternate dependencies or re-download the same dependency from the third-party system 201. The dependency resolver 370 after resolving the failure, causes the build and deployment tool to reinitiate the build process again.

FIG. 6 provides a process flow 600 for dynamically generating dependency libraries associated with disparate frameworks, in accordance with an embodiment of the invention. As shown in block 605, the system crawls into one or more code repositories comprising one or more codes that are associated with one or more applications. In some embodiments, the system may crawl into the one or more code repositories after identifying that the user has checked-in a code associated with a software application into the one or more code repositories.

As shown in block 610, the system identifies, via a machine learning model, one or more dependencies associated with the one or more codes based on crawling into the one or more code repositories. In some embodiments, the one or more dependencies may be provided by a user who is developing the code. In some embodiments, the system may identify the one or more dependencies automatically. In such embodiments, the system, via the machine learning model, identifies the one or more dependencies that are associated with the one or more codes in the one or more code repositories. The system initially trains the machine learning model using historical data which may include previous dependency related data, keywords associated with the dependencies, or the like. Based on the training data and the training, the machine learning model identifies the one or more dependencies.

As shown in block 615, the system determines if the one or more dependencies are present in internal library repository. In an embodiment, where the system identifies that the one or more dependencies are present in the internal library repository, the process flow moves to block 620. As shown in block 620, the system generates the dependency libraries by downloading the one or more dependencies from the internal library repository. In some embodiments, the system stores the dependency libraries in a cached library, where the dependency libraries are ready to be utilized in a build and deploy phase. Internal library repository may be stored in a repository, which may include one or more dependency libraries. The one or more dependency libraries in the repository may be associated with disparate frameworks.

In an embodiment, where the system identifies that the one or more dependencies are present in the internal library repository, the process flow moves to block 621. As shown in block 621, the system generates the dependency libraries by downloading the one or more dependencies from at least one third party entity system. In some embodiments, the at least one third party entity system may be a website or third-party entity that is on an approved or safe to access list provided by the entity.

In some embodiments, the dependency libraries generated by the system may be used by the system for generation of similar dependency libraries. For example, if a code submitted by a user at a later time period requires the same dependency libraries as that of the dependency libraries that are already downloaded by the system, the system instead of downloading the dependency libraries again, utilizes the existing dependency libraries, thereby improves the efficiency of the process. In other words, the system may store the downloaded dependency libraries in the internal library repository.

As shown in block 625, the system provides the one or more dependencies downloaded from the internal library repository for building the one or more codes for deployment. A build and deployment tool may bundle the one or more codes and the one or more dependencies and create a package ready for deployment to a next environment.

As shown in block 630, the system identifies, via the machine learning model, a failure associated with building the one or more codes for deployment. In the case, the build process fails, the system identifies the cause of the failure by accessing one or more logs. As shown in block 635, the system resolves the failure associated with building the one or more codes for deployment. In some embodiments, the system may identify that the cause of the failure is due to non-existent dependencies. In such embodiments, the system may automatically redownload the non-existent dependencies from a third-party entity system. In alternate embodiments, the system may automatically identify alternate dependencies that can replace existing dependencies in the internal library repository. For example, if a dependency present in the internal library repository is outdated, the system may identify that the outdated dependency is the cause of the failure and download an alternative dependency such as a most recent version of the dependency. The system may then replaces the outdated existing dependency in the internal library repository with the alternative dependency.

As shown in block 640, the system reinitiates the building of the one or more codes for deployment. The system after resolving the cause of the failure, reinitiates the build process. In some embodiments, the system may transmit a trigger to the build and deploy tool to reinitiate the build and deploy process in response to resolving the cause of the failure. As shown in block 645, the system provides information associated with the failure to the machine learning model and train the machine learning model, thereby preventing the occurrence of the same failure.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for dynamic generation of dependency libraries associated with disparate frameworks, comprising:
at least one processing device;
at least one memory device; and
a module stored in the at least one memory device comprising executable instructions that when executed by the at least one processing device, cause the at least one processing device to:
crawl into at least one code repository comprising one or more codes that are associated with one or more applications, wherein the one or more applications are associated with disparate frameworks;
identify, via a machine learning model, one or more dependencies associated with the one or more codes based on crawling into the at least one code repository;
determine that the one or more dependencies are present in an internal library repository, wherein the internal library repository is provided by an entity system;
generate dependency libraries by downloading the one or more dependencies from the internal library repository; and
provide the one or more dependencies downloaded from the internal library repository to a build and deploy tool for building the one or more codes for deployment.

2. The system according to claim 1, wherein the one or more applications are in development phase.

3. The system according to claim 1, wherein the executable instructions cause the at least one processing device to crawl into the at least one code repository based on identifying that at least one user checked in the one or more codes to the at least one code repository.

4. The system according to claim 1, wherein the executable instructions cause the at least one processing device to identify the one or more dependencies based on automatically reading the one or more codes in the one or more codes repositories.

5. The system according to claim 1, wherein the executable instructions cause the at least one processing device to identify the one or more dependencies based on automatically reading one or more inputs provided by at least one user while developing the one or more codes.

6. The system according to claim 1, wherein the executable instructions cause the at least one processing device to:
identify, that the one or more dependencies associated with the one or more codes are not present in the internal library repository; and
generate the dependency libraries by downloading the one or more dependencies from at least one third party entity system.

7. The system according to claim 1, wherein the executable instructions cause the at least one processing device to:
identify, via the machine learning model, a failure associated with building the one or more codes for deployment; and
resolve the failure associated with building the one or more codes for deployment.

8. The system according to claim 7, wherein the executable instructions cause the at least one processing device to identify that the failure associated with building the one or more codes based on determining that at least one dependency of the one or more dependencies is non-existent.

9. The system according to claim 8, wherein the executable instructions cause the at least one processing device to resolve the failure by downloading the at least one dependency that is non-existent.

10. The system according to claim 7, wherein the executable instructions cause the at least one processing device to provide information associated with the failure to the machine learning model and train the machine learning model.

11. A computer program product for dynamic generation of dependency libraries associated with disparate frameworks, comprising a non-transitory computer-readable storage medium having computer-executable instructions for:
crawling into at least one code repository comprising one or more codes that are associated with one or more applications, wherein the one or more applications are associated with disparate frameworks;
identifying, via a machine learning model, one or more dependencies associated with the one or more codes based on crawling into the at least one code repository;
determining that the one or more dependencies are present in an internal library repository, wherein the internal library repository is provided by an entity system;
generate dependency libraries by downloading the one or more dependencies from the internal library repository; and
providing the one or more dependencies downloaded from the internal library repository to a build and deploy tool for building the one or more codes for deployment.

12. The computer program product according to claim 11, wherein the non-transitory computer-readable storage medium comprises computer-executable instructions for crawling into the at least one code repository based on identifying that at least one user checked in the one or more codes to the at least one code repository.

13. The computer program product according to claim 11, wherein the non-transitory computer-readable storage medium comprises computer-executable instructions for identifying the one or more dependencies based on automatically reading the one or more codes in the one or more codes repositories.

14. The computer program product according to claim 11, wherein the non-transitory computer-readable storage medium comprises computer-executable instructions for:
identifying, that the one or more dependencies associated with the one or more codes are not present in the internal library repository; and
generating the dependency libraries by downloading the one or more dependencies from at least one third party entity system.

15. The computer program product according to claim 11, wherein the non-transitory computer-readable storage medium comprises computer-executable instructions for:
identifying, via the machine learning model, a failure associated with building the one or more codes for deployment; and
resolving the failure associated with building the one or more codes for deployment.

16. A computerized method for dynamic generation of dependency libraries associated with disparate frameworks, comprising:
crawling into at least one code repository comprising one or more codes that are associated with one or more applications, wherein the one or more applications are associated with disparate frameworks;
identifying, via a machine learning model, one or more dependencies associated with the one or more codes based on crawling into the at least one code repository;
determining that the one or more dependencies are present in an internal library repository, wherein the internal library repository is provided by an entity system;
generate dependency libraries by downloading the one or more dependencies from the internal library repository; and
providing provide the one or more dependencies downloaded from the internal library repository to a build and deploy tool for building the one or more codes for deployment.

17. The computerized method according to claim 16, wherein the method of crawling into the at least one code repository is based on identifying that at least one user checked in the one or more codes to the at least one code repository.

18. The computerized method according to claim 16, wherein the method of identifying the one or more dependencies is based on automatically reading the one or more codes in the one or more codes repositories.

19. The computerized method according to claim 16, wherein the method further comprises:
identifying, that the one or more dependencies associated with the one or more codes are not present in the internal library repository; and
generating the dependency libraries by downloading the one or more dependencies from at least one third party entity system.

20. The computerized method according to claim 16, wherein the method further comprises:
identifying, via the machine learning model, a failure associated with building the one or more codes for deployment; and
resolving the failure associated with building the one or more codes for deployment.
